(19) United States
(12) Patent Application Publication
(10) Pub. No.: US 2020/0240855 A1
(43) Pub. Date: Jul. 30, 2020

(54) OBJECT DEFORMATION DETECTION USING CAPACITIVE SENSING

(71) Applicant: Cirque Corporation, Salt Lake City, UT (US)

(72) Inventors: JON BERTRAND, Taylorsville, UT (US); JARED BYTHEWAY, Sandy, UT (US); BRIAN MONSON, Farmington, UT (US); PATRICK SHERWOOD, Salt Lake City, UT (US); DOUGLAS STECK, Riverton, UT (US)

(73) Assignee: Cirque Corporation, Salt Lake City, UT (US)

(21) Appl. No.: 16/750,995

(22) Filed: Jan. 23, 2020

Related U.S. Application Data
(60) Provisional application No. 62/796,447, filed on Jan. 24, 2019.

(51) Int. Cl. G01L 1/14; E05F 15/46; E05F 15/48

(52) U.S. Cl. CPC G01L 1/144; E05F 15/48; E05F 15/46; G01L 1/146

(57) ABSTRACT

A deformable sensor may detect changes in capacitance due to relative motion of electrodes in the deformable sensor, or due to a proximate object. In some cases, a controller circuit may communicate with a motion interface system to alter motion of system components when a deformation or proximate object is sensed.

### CROSS REFERENCE TO RELATED APPLICATIONS

The present Application claims priority to U.S. Provisional Patent Application No. 62/796,447 by Jon Bertrand et al., entitled “Object Deformation Detection Using Capacitive Sensing,” filed on Jan. 24, 2019, assigned to the assignee hereof, and expressly incorporated by reference herein.

### FIELD OF THE DISCLOSURE

This disclosure relates generally to using capacitive sensing to detect a potential pinching or crushing of an object, or to induce a motive response. More particularly, this disclosure relates to capacitive sensors in a gasket or other flexible material that may be mounted to a non-flexible material to detect potential pinching or crushing of an object by the non-flexible material, or to change the motion of a portion or component of the system.

### BACKGROUND

Many non-flexible objects, such as vehicle doors, garage doors, refrigerator doors, hinged doors, windows, garbage can lids, other types of lids, shipping containers, other types of containers, sliding doors, gates, revolving doors, rotary objects, or the like, often present a pinching or crushing hazard for hands, fingers, or other objects. Additionally, many of these same non-flexible objects often include a flexible member, such as a gasket or other seal, that is used to provide a weather-tight seal. In existing devices, the flexible member typically has no function other than to seal the door or other non-flexible object. Thus, there is often no way to warn, prevent, or otherwise inhibit the pinching or crushing of an object that gets in the path of the non-flexible object or door when it is operating.

For existing systems that do include some type of crush or pinch detection it is often a separate system, such as an optical beam detector, or the like, that adds to the overall complexity and cost of the device. Other drawbacks, inconveniences, and issues with existing devices and methods also exist.

### SUMMARY

Accordingly, disclosed embodiments address the above-noted, and other, drawbacks, inconveniences, and issues with existing devices and methods. In one disclosed embodiment there is provided a flexible or otherwise deformable sensor that comprises a flexible gasket. Embodiments of the flexible gasket house a number of electrodes. The electrodes are in communication with a touch controller circuit. The touch controller circuit communicates with a motion interface system that interacts with the moving parts upon which the deformable sensor is installed as outlined below. Other advantages, features, and methods of operation of the disclosed embodiments will be apparent to those of ordinary skill in the art having the benefit of this disclosure.

In some embodiments, an apparatus may include a deformation sensor, the deformation sensor being made of a deformable material, an electrode incorporated into the deformation sensor, an electrically conductive member being spaced apart from the first electrode at a distance and being incorporated into the deformation sensor; and a controller programmed to determine when the distance between the electrode and the electrically conductive member changes by measuring changes in capacitance between the electrode and the electrically conductive member.

The deformation sensor may include a hollow interior and the electrode and the electrically conductive member are positioned within the hollow interior.

At least one of the electrode and the electrically conductive member may include an electrically insulating coating.

The electrode may be electrically insulated from the electrically conductive member.

The electrically conductive member may be a second electrode.

The deformation sensor may include a floating coupler.

The apparatus may include a closure assembly. The closure assembly may include a first member having a first surface, a second member having a second surface. The second member may be movable to bring the first surface and the second surface into close proximity to each other and the deformation sensor may be disposed adjacent to at least one of the first surface and the second surface.

The first member may be a window frame and the second member is a window.

The first member may be a door frame and the second member is a door.

The first member may be a door frame and the second member is a sliding door.

The second member may be a sliding door.

The second member may be a revolving door.

The second member may be movable with a power assembly.

The controller may be programmed to move the second member away from the first member when a measured capacitance increases.

In some examples, an apparatus may include a first member of a closure assembly, a second member of the closure assembly movable with respect to the first member where movement of the second member is powered with a power assembly, a deformation sensor incorporating an electrode, and a controller programmed to measure a change in capacitance with the electrode. In some cases,

The command may be to move the second member away from the first member.

The command may be to stop movement of the second member.

The second member may be sliding member.

The second member may be rotary member.

The second member may be a hinged member.

In some examples, the deformation sensor may be a sealing member.

In some examples, the deformation sensor may include a gasket.

In some examples, the deformation sensor is an elongated member.

### BRIEF DESCRIPTION OF THE DRAWINGS

FIG. 1 depicts an example of a deformation sensor system in accordance with disclosed embodiments.

FIG. 2 is an end-view, cross-sectional schematic showing a deformation of sensor of the system shown in FIG. 1 in accordance with disclosed embodiments.

FIG. 3 depicts an example of a segmented deformable sensor in accordance with disclosed embodiments.

FIG. 4 depicts an example of a deformable sensor installed on a vehicle door in accordance with disclosed embodiments.

FIG. 5 depicts an example of a deformable sensor installed on an overhead door in accordance with disclosed embodiments.

FIG. 6 depicts an example of a deformable proximity sensor system in accordance with disclosed embodiments.

FIG. 7 depicts an example of a deformation sensor system in accordance with disclosed embodiments.

FIG. 8A depicts an example of a deformation sensor system in accordance with disclosed embodiments.

FIG. 8B depicts an example of a deformation sensor system in accordance with disclosed embodiments.

FIG. 9A depicts an example of a deformation sensor incorporated into a sliding member system in accordance with disclosed embodiments.

FIG. 9B depicts an example of a deformation sensor incorporated into a sliding member system in accordance with disclosed embodiments.

FIG. 10 depicts an example of a deformation sensor incorporated into a sliding member system in accordance with disclosed embodiments.

FIG. 11 depicts an example of a deformation sensor incorporated into a rotary member system in accordance with disclosed embodiments.

FIG. 12 depicts an example of a deformation sensor incorporated into a rotary member system in accordance with disclosed embodiments.

FIG. 13 depicts an example of a deformation sensor incorporated into a sliding door system in accordance with disclosed embodiments.

FIG. 14 depicts an example of a deformation sensor incorporated into a hinged door system in accordance with disclosed embodiments.

FIG. 15 depicts an example of a deformation sensor incorporated into a garage door system in accordance with disclosed embodiments.

FIG. 16 depicts an example of a method of using a deformation sensor in accordance with disclosed embodiments.

FIG. 17 depicts an example of a method of using a deformation sensor in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION OF THE INVENTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted, or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

For purposes of this disclosure, the term “aligned” generally refers to being parallel, substantially parallel, or forming an angle of less than 35.0 degrees. For purposes of this disclosure, the term “transverse” generally refers to perpendicular, substantially perpendicular, or forming an angle between 55.0 and 125.0 degrees. For purposes of this disclosure, the term “length” generally refers to the longest dimension of an object. For purposes of this disclosure, the term “width” generally refers to the dimension of an object from side to side and may refer to measuring across an object perpendicular to the object's length.

For purposes of this disclosure, the term “electrode” generally refers to a portion of an electrical conductor intended to be used to make a measurement, and the terms “route” and “trace” generally refer to portions of an electrical conductor that are not intended to make a measurement. For purposes of this disclosure in reference to circuits, the term “line” generally refers to the combination of an electrode and a “route” or “trace” portions of the electrical conductor. For purposes of this disclosure, the term “Tx” generally refers to a transmit line, and the term “Rx” generally refers to a sense line.

It should be understood that use of the terms “touch pad” and “touch sensor” throughout this document may be used interchangeably with “capacitive touch sensor,” “capacitive sensor,” “capacitive touch and proximity sensor,” “proximity sensor,” “touch and proximity sensor,” “touch panel,” “touchpad,” and “touch screen.”

It should also be understood that, as used herein, the terms “vertical,” “horizontal,” “lateral,” “upper,” “lower,” “left,” “right,” “inner,” “outer,” etc., can refer to relative directions or positions of features in the disclosed devices and/or assemblies shown in the Figures. For example, “upper” or “uppermost” can refer to a feature positioned closer to the top of a page than another feature. These terms, however, should be construed broadly to include devices and/or assemblies having other orientations, such as inverted or inclined orientations where top/bottom, over/under, above/below, up/down, and left/right can be interchanged depending on the orientation.

Capacitance touch systems may be built to detect changes in an electric field. Any change in the environment near the sensor may change the electric field. Capacitance touch systems may measure charge movement that may be correlated with a stimulus signal which may directly relate to the behavior of the electric field. Theses sensors may then monitor absolute measurements for changes, thus allowing the system to monitor for changes in the electric field. Given the proper frame of reference, the changes in charge movement can be used to track an object's arrival, departure, or position near the sensor.

Typically, a touch controller includes at least one of a central processing unit (CPU), a digital signal processor (DSP), an analog front end (AFE) including amplifiers, a peripheral interface controller (PIC), another type of microprocessor, and/or combinations thereof, and may be implemented as an integrated circuit, a field programmable gate array (FPGA), an application specific integrated circuit (ASIC), a combination of logic gate circuitry, other types of digital or analog electrical design components, or combinations thereof, with appropriate circuitry, hardware, firmware, and/or software to choose from available modes of operation for the touch sensor (e.g., self-capacitive sensing, mutual capacitive sensing, or the like).

Typically, a touch controller also includes at least one multiplexing circuit to alternate which electrodes are operating as a drive electrode or a sense electrode. The driving electrodes can be driven one at a time in sequence, or randomly, or all at the same time in encoded patterns. Other configurations are possible such as self-capacitance mode where the electrodes are driven and sensed simultaneously. Other configurations are also possible.

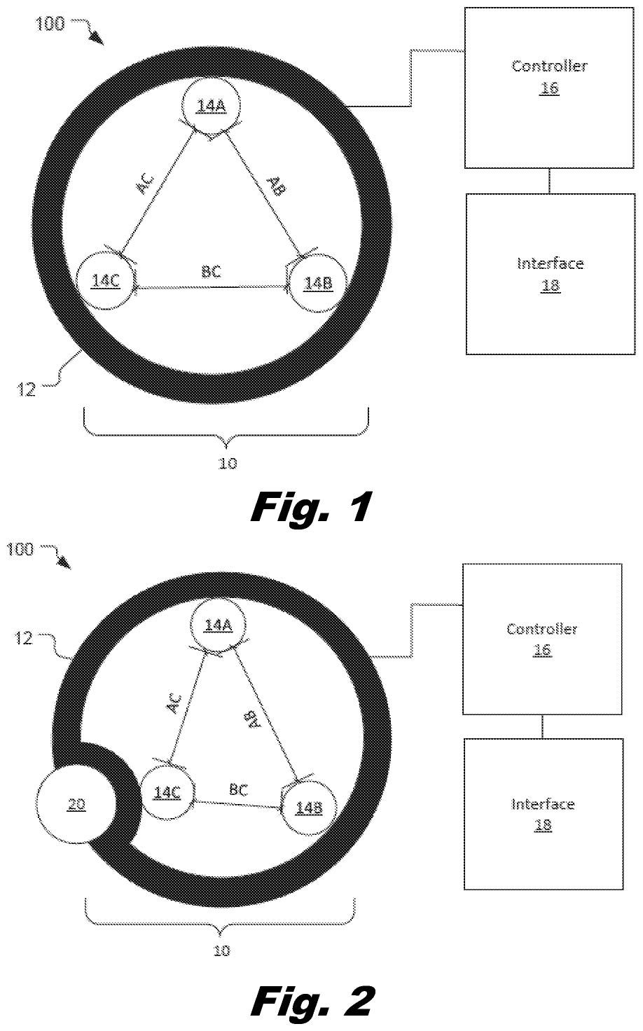

FIG. 1 is an end-view, cross-sectional schematic of a deformation sensor system 100 in accordance with disclosed embodiments. As shown, system 100 includes a flexible or otherwise deformable sensor 10 that comprises a flexible gasket 12. Gasket 12 may comprise any suitable material for a given application. For example, if the deformation sensor system 100 is to be installed on a vehicle door, or the like, gasket 12 may comprise a rubber, or rubber-like material that compresses when the door is shut and additionally functions to seal the interface between the door and vehicle frame. Gasket 12 is shown in FIG. 1 as having a generally circular cross-section, but other shapes are also possible as one of ordinary skill in the art having the benefit of this disclosure would understand.

As shown in this embodiment, gasket 12 houses a number of electrodes 14 (three electrodes 14A-14C are shown in FIG. 1). While three electrodes 14A-C are shown in FIG. 1 that is merely exemplary and any suitable number of electrodes may be used as further disclosed herein. Likewise, electrodes 14A-C are shown as being spaced generally equidistantly (i.e., distance AC=distance AB=distance BC), but that is exemplary and other configurations may be used.

As indicated schematically, electrodes 14A-C are in communication with a touch controller circuit 16 which, as generally described above, controls the driving and sensing functions of the electrodes 14A-C in order to create electric fields, and detect changes in capacitance, and the like. Among other things, touch controller circuit 16 can be “tuned” to accommodate any particular geometry, arrangement, and configuration of electrodes 14. In other words, because the change in capacitance due to deformation is detected, the original configuration may not be critical other than to set a baseline capacitance value in the touch controller circuit 16.

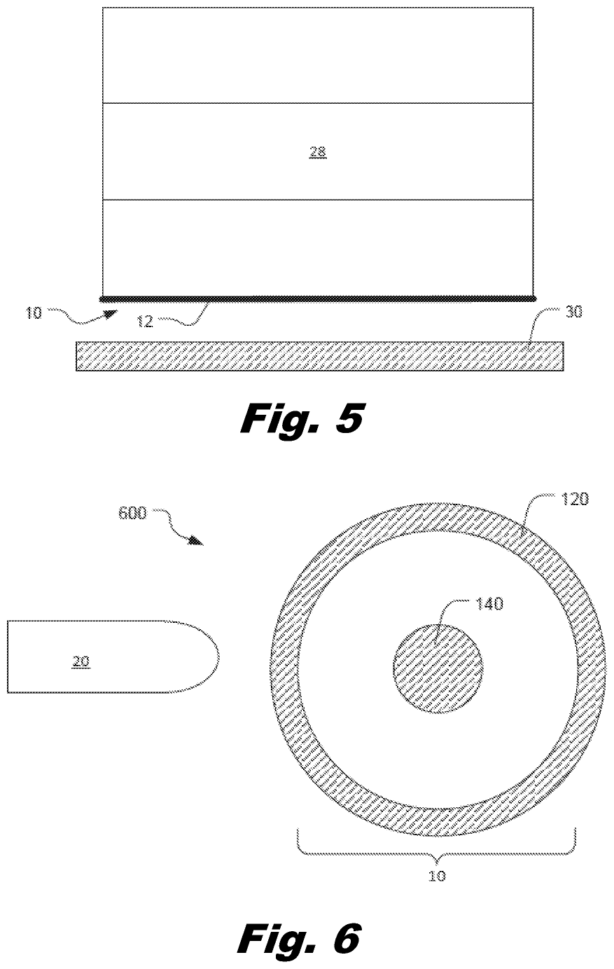

As also indicated schematically, touch controller circuit 16 communicates with a motion interface system 18 that interacts with the moving parts upon which the deformable sensor 10 is installed as outlined below. In embodiments where deformable sensor 10 is installed on a moving door, for example FIGS. 4-5, motion interface system 18 may comprise a motion interrupter, such as a locking hinge, a shaft, gearing, a reversible motor, or the like that, when a deformation of sensor 10 is detected, causes the motion of the door to be arrested, reversed, slowed, or the like. As a person of ordinary skill in the art having the benefit of this disclosure would understand, other motion interface systems 18 may also be used such as brakes, clutches, transmissions, or the like. Additionally, the motion interface systems 18 need not be mechanical, and electronic “kill switches” or the like may be used. Furthermore, in some embodiments, motion interface systems 18 need not arrest or change the motion of the moving part(s), but may trigger an alarm (visual, audible, vibratory, combinations thereof, or the like).

Additionally, embodiments of system 100 may be configured so that sensing of a deformation or object in proximity to gasket 12 (and electrodes 14A-C) causes motion interface system 18 to move a portion of the system 100 (e.g., open a door, window, gate, or the like). For example, for embodiments of system 100 that are installed on a refrigerator a predetermined number of presses on, or a “swipe” along, gasket 12 may cause motion interface system 18 to open the refrigerator door.

FIG. 2 is an end-view, cross-sectional schematic showing a deformation of sensor 10 of the system 100 as shown in FIG. 1 in accordance with disclosed embodiments. FIG. 1 shows the system 100 in an initial, undeformed state for deformable sensor 10 and FIG. 2 shows the sensor 10 during a deformation of sensor 10 by an object 20. As shown, flexible gasket 12 is deformed by the object 20 (which may be a finger, hand, or any other object). That deformation causes at least one of the electrodes 14 (in FIG. 2, electrode 14C) to move and change the relative locations of the electrodes 14A-C (i.e., distance AC distance BC) which also changes the sensed capacitance value of the electrodes 14A-C by touch controller circuit 16. As discussed above, touch controller circuit 16 may also communicate to motion interface system 18 upon sensing a change in capacitance that indicates the presence of an object 20.

As one of ordinary skill in the art having the benefit of this disclosure would understand, embodiments of touch controller circuit 16 may be programmed or designed to differentiate between deformation or proximity sensing due to an object 20 and deformation or proximity sensing due to initial states of the system 100. For example, for embodiments of system 100 installed on a vehicle door, deformation of gasket 12 due to the door being closed would be recognized by touch controller circuit 16 as a baseline closed state or the like.

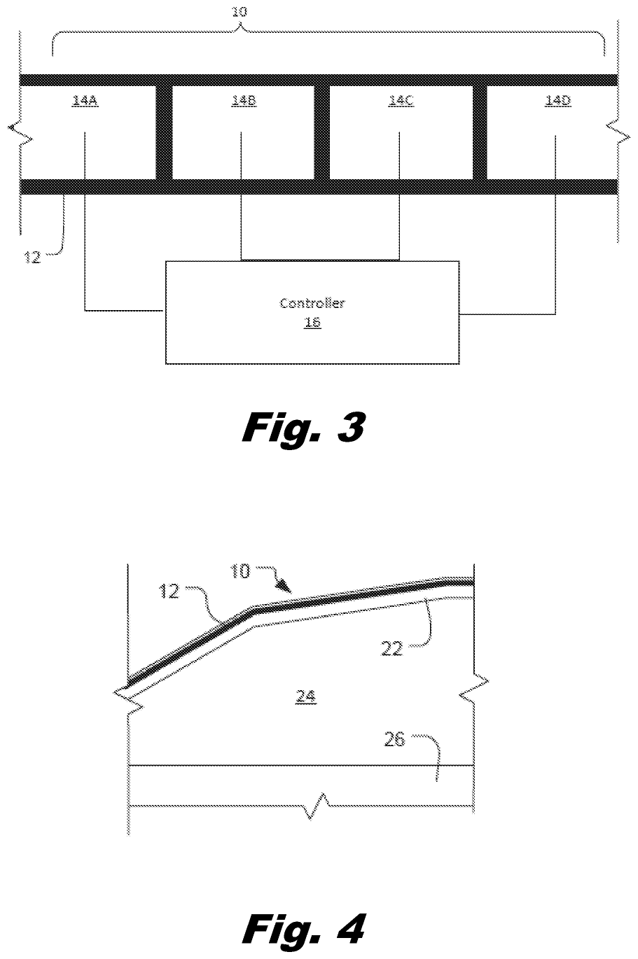

FIG. 3 is a schematic illustration of a segmented deformable sensor 10 in accordance with disclosed embodiments. As indicated in FIG. 3, embodiments of deformable sensor 10 may comprise discrete, or otherwise segmented electrodes 14A-D that, among other things, may provide more precise information to touch controller circuit 16 regarding the location of an object (not shown in FIG. 3) that is deforming the sensor 10. For example, if touch controller circuit 16 senses a change in capacitance from only electrode 14B, then that information may be communicated to a motion interface system (not shown in FIG. 3) and only portions of the motion may be altered, or the like. Likewise, as discussed above, for embodiments installed on a vehicle door or the like, segmented electrodes 14A-D may be used to indicate the presence of a finger or other object 20 in the path of proper door closure by a deformation or proximity sensing in a single segment or the like. Other uses for a segmented deformable sensor 10 and responses by a motion interface system 18 are also possible.

FIG. 4 is a schematic partial illustration of a deformable sensor 10 installed on a vehicle door in accordance with disclosed embodiments. As indicated, flexible gasket 12 may be installed on an upper portion 22 of a vehicle door above a window 24 as is customary in many vehicle doors 26. In the event a finger, hand, or other object (not shown in FIG. 4) gets pinched between the upper portion 22 of the door 26 and the vehicle frame (not shown in FIG. 4) the deformable sensor 10 may signal a change in capacitance that is sensed by touch controller circuit 16 and communicated to motion interface systems 18 (both not shown in FIG. 4) and arrest or otherwise alter the motion of the door 26 to prevent injury or the like.

Similarly, for embodiments where gasket 12 is installed around window 24 (e.g., to seal the closed window 24 against upper portion 22 of the door 26) a predetermined number or pattern of touches on gasket 12 may cause the window to open, close, or otherwise move. Additionally, a normal closed (or open) state may be recognized by the touch controller 16 (not shown in FIG. 4) for either the window 24 or the door 26 and deviations from those normal states may trigger anti-theft systems (not shown) on the vehicle or the like.

FIG. 5 is a schematic illustration of a deformable sensor 10 installed on an overhead door 28 in accordance with disclosed embodiments. As indicated in FIG. 5, an overhead door 28 (i.e., a garage door or the like) may include a flexible gasket 12 on the end of the door 28 that contacts the ground 30. As disclosed herein, when a deformation of sensor 10 is sensed, the motion interface systems may arrest, open, or otherwise alter the motion of the door 28.

FIG. 6 is a schematic illustration of a deformable proximity sensor system 600 in accordance with disclosed embodiments. As discussed herein, in some embodiments, it may be desirable to detect an object 20 prior to deformation of sensor 10, thus, sensor 10 may be configured to sense changes in capacitance due to the proximity of an object 20. For example, sensor 10 may comprise a flexible, conducting material that functions as one of the system 600 electrodes 120. Another of the system 600 electrodes 140 may be located within flexible electrode 120. In some embodiments, sufficient electrodes are provided so that proximity sensing may be performed in addition to, or instead of, deformation sensing. As disclosed herein, bringing a finger or object 20 in proximity to the flexible electrode 120 may cause the system 600 to open, close, or otherwise alter the motion of one or more motive components (e.g., a door, window, or the like). Other configurations may also be used.

FIG. 7 depicts an example of a deformation sensor 700. In this example, the deformation sensor 700 includes a gasket material 702 that is deformable, a first electrode 704 disposed within a hollow interior 706 of the gasket material 702, and a second electrode 708 disposed within the hollow interior 706. In this example, the first and second electrodes 704, 708 include an electrically insulating coating 710 on an exterior surface of the electrodes 704, 708. In the illustrated example, the electrically insulating coating 710 surrounds the electrodes 704, 708. But, in other configurations, the electrically insulating material may cover just a portion of an exterior of the electrodes 704, 708.

In some cases where the force on the deformation sensor 700 causes the first and second electrodes 704, 708 to move toward each other, the electrically insulating coating 710 may prevent the first and second electrodes 704, 708 from shorting out or otherwise forming an electrically conductive contact between each other. In some examples, the electrically insulating coating 710 may prevent the capacitance signals from being altered as though an electrically conducting contact was otherwise formed between the first and second electrodes 704, 708.

In the example of FIG. 7, the deformation sensor 700 includes just two electrodes. In some examples where just two electrodes are used, the first electrode 704 may be a transmit electrode and the second electrode 708 may be a sense electrode. In this particular example, the transmit electrode 704 may carry a voltage, and the sense electrode may measure the capacitance between the two electrodes as the voltage is carried by the transmit electrode. When the distance between the two electrodes is different, the measured amount of capacitance between the electrodes may be different.

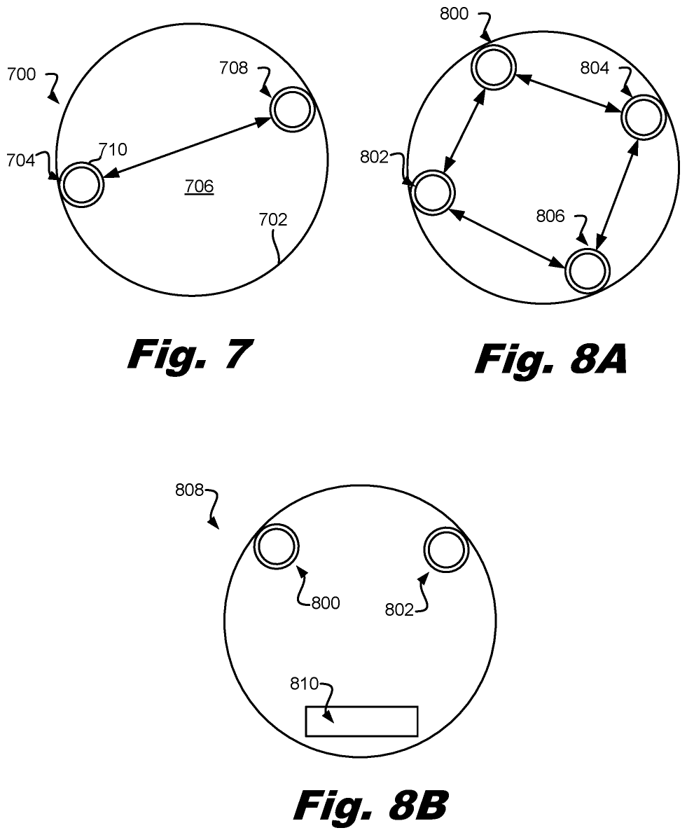

However, any appropriate number of electrodes may be used. For example, FIG. 8 includes a first electrode 800, a second electrode 802, a third electrode 804, and a fourth electrode 806. In some examples, just one of the electrodes may be a transmit electrode and the other electrodes may be sense electrodes. However, in other examples, multiple transmit electrodes may be included.

In an alternative example, the deformation sensor 808 may include a first electrode 800 and a second electrode 802. In some examples, the first electrode 800 may be a transmit electrode, and the second electrode 802 may be a sense electrode, or vice versa. The deformation sensor 808 may also include a floating coupler 810. In some cases, the floating coupler may be an electrically conductive material that is not grounded. However, the distance between the electrodes 800, 802 and the floating coupler 810 may affect the capacitance measurement. In some situations, as the deformation sensor 808 is compressed, the distance between the floating coupler 810 and the electrodes 800, 802 may decrease causing a change in the capacitance measurement. In such a situation, the controller may determine that there has been a pinch or another type of deformation based on the change in capacitance.

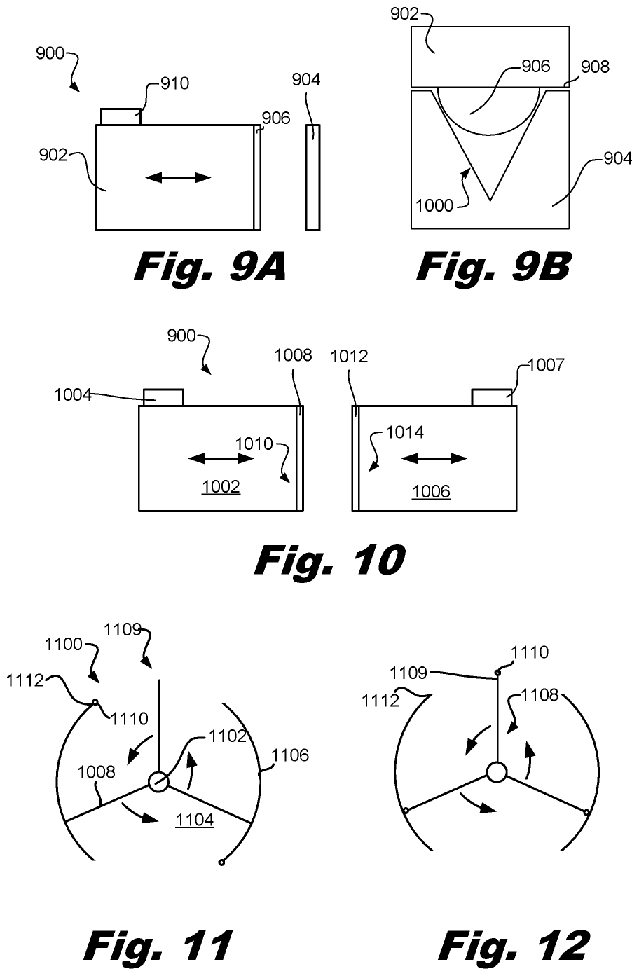

FIG. 9A depicts an example of a closure assembly 900. In this example, the closure assembly 900 includes a sliding member 902, a fixed member 904, a deformation sensor 906 attached to a leading edge 908 of the sliding member 902, and a power assembly 910. In this example, the power assembly 910 can move the sliding member 902 towards or away from the fixed member 904. While this example depicts the deformation sensor 906 attached to the sliding member 902, in other examples, the deformation sensor 906 may be attached to the fixed member 904.

The power assembly 910 may include a motor, a pump, a linear actuator, or another type of assembly that can apply power to cause the sliding member 902 to move. In some examples, the power assembly 910 may have the ability to cause the sliding member to move in two directions.

The power assembly 910 may also include a controller that receives signals from the deformation signal. In some examples, if the signal from the deformation sensor 906 indicates that the capacitance has increased, decreased, or otherwise changed when the sliding member 902 is moving towards the fixed member 904, the controller may send a signal that causes the power assembly 910 to reverse the direction of the sliding member 902, halt the movement of the sliding member 902, slow down the movement of the sliding member 902, disconnect the sliding member 902 from the power assembly 902, or otherwise affect the movement, speed, power, or direction of the sliding member 902.

The deformation sensor 906 may be deformed as a result of a person, hand, leg, another type of body part, a box, a cart, or another type of object being in the way of the sliding door 902. In some examples when the deformation sensor 906 is on the leading edge 908 of the sliding member 902, the deformation sensor 906 comes into contact with the body part of other type of object first, thereby generating a deformation signal from the deformation sensor 906 as deformation sensor 906 is being pinched.

In some cases, the controller is also aware of the position of the leading edge 908 of the sliding member 902. The controller may receive input from other sensors that can determine the position of the leading edge 908, such as cameras, radar, optical sensors, other types of sensors, and so forth. In some embodiments when the leading edge 908 of the sliding member 902 approaches the fixed member 904, the deformation sensor 906 may create a seal between the sliding member 902 and the fixed member 904. As the seal is being created, the electrodes in the deformation sensor 906 may change their relative position with each other causing a change in capacitance. In this type of example, the controller may determine that location of the deformation sensor 906 is at that position where the seal should be created and not send a signal to the power assembly 910.

In some cases, the capacitance change that results from forming a seal is different from the capacitance change that results from a person's hand or other body part being pinched with the deformation sensor 906. In this type of example, the controller may distinguish between forming a seal and pinching an object with the deformation sensor 906.

In another example, as depicted in FIG. 9B, the deformation sensor 906 protrudes beyond the leading edge 908 of the sliding member 902, and the fixed member 904 includes a recess 1000 that receives the deformation member 906. In this example, the deformation member 906 may or may not contribute to forming a seal between the sliding member 902 and the fixed member 904. In some cases in the illustrated example of FIG. 9B, when the sliding member 902 and the fixed member 904 are together, the deformation sensor 906 may not be altered such that a change is capacitance is triggered.

FIG. 10 depicts an example, where a closure assembly 900 includes a first sliding member 1002 powered with a first power assembly 1004 and a second sliding member 1006 powered by a second power assembly 1007. A first deformation sensor 1008 may be attached to a first leading edge 1010 of the first sliding member 1002, and a second deformation sensor 1012 may be attached to a second leading edge 1014 of the second sliding member 1006. In this example, both sliding members 1002, 1006 may detect when obstacles are encountered. In some examples, the first and second deformation sensors 1008, 1012 may not be deformed when the first and second sliding members 1002, 1006 come into contact with each other when no objects are pinched between the first and second sliding members 1002, 1006. In alternative examples, the seal created by the deformation sensors 1008, 1012 may have a distinctive signal characteristic that is distinguishable from the signals that would otherwise result if an object were pinched between the first and second sliding members 1002, 1006.

In some examples when the deformation forms the seal, the seal is a light seal that may prevent a breeze or another type fluid from moving past the deformation sensor at a low force. In this type of example, the force pushing the deformation sensor into contact with another surface may be low enough that the electrodes in the deformation sensor are not significantly moved. On the other hand, when an object is pinched with the deformation sensor, at least one of the electrodes may move a relatively significant distance with respect to the other electrode causing a greater capacitance change.

In some examples, a controller in the first power assembly 1004 may send a signal to the controller in the second power assembly 1007 when the signal from the first deformation sensor 1008 indicates that an object has been encountered. Based on the signal from the first controller, the second sliding member 1006 may be caused to react to reverse its direction or otherwise respond as thought the signal had come from the second deformation sensor 1012.

The closure members 900 depicted in FIGS. 9 and 10 may be any appropriate type of closure member. For example, the closure members may be a power window, a motorized sliding door on a car, an automatic door into a building, a gate, incorporated into a fence, a garage door, another type of closure member, or combinations thereof.

FIGS. 11 and 12 depict examples of closure assemblies 1100 involving a rotary member 1102. In these examples, the closure assembly 1100 may include a revolving door. In this example, the rotary member 1102 may be located within a chamber 1104 partially defined by an enclosure 1106. Panels 1108 may extend away from the rotary member 1102 towards the surface of the enclosure 1106 to temporarily provide an ingress and egress to the enclosure as the rotary member 1102 is rotating. In some cases, a small gap may be formed between the outer most edge 1109 of the panels 1108 and the surface of the enclosure 1106 as the panel moves through the enclosure 1106. In other examples, no gap may exist.

In the example depicted in FIG. 11, a deformation sensor 1110 is attached to a fixed edge 1112 of the enclosure 1106. As the outer most edge 1109 of the panel 1108 approaches the fixed edge 1112 of the enclosure 1106, the outer most edge 1109 and the fixed edge 1112 may come together or closely together. In some examples, when there are no objects positioned to obstruct the movement of the panels 1108, the outer most edge 1109 of the panel 1108 may pass by the deformation sensor 1110 without deforming the deformation sensor 1110. In this type of example, a controller of a power assembly causing the rotary member 1102 to move may receive no signals from the deformation sensor 1110 that would result in altering the speed, power, force, or direction of the rotary member 1102.

In a different scenario where an object such as a hand or other body part are pinched between the outer most edge 1109 of the panel 1108 and the fixed edge 1112 of the enclosure 1106, the deformation sensor may be deformed, causing a change in the measured capacitance. The change of capacitance may result in the controller altering the speed, power, and/or the direction of the rotary member 1102. For example, if an object is pinched, the controller may cause the rotary member to rotate in an opposite direction to free the object. In other examples, the controller may cause the rotary member to disengaged from the power assembly so that a user can manually move the panel 1108 to free the object.

In the example of FIG. 12, the deformation sensor 1110 is located on the outer most edge 1109 of the panel 1108. In some examples where there are no obstructions, the deformation sensor 1110 may move past the fixed edge 1112 without receiving push back by the fixed edge 1112 that would cause the deformation sensor 1110 to deform. However, in other scenarios where an object is being pinched between the panel 1108 and the fixed edge 1112, the deformation sensor 1110 may be deformed triggering a command to alter how the power assembly is interacting with the rotary member 1102.

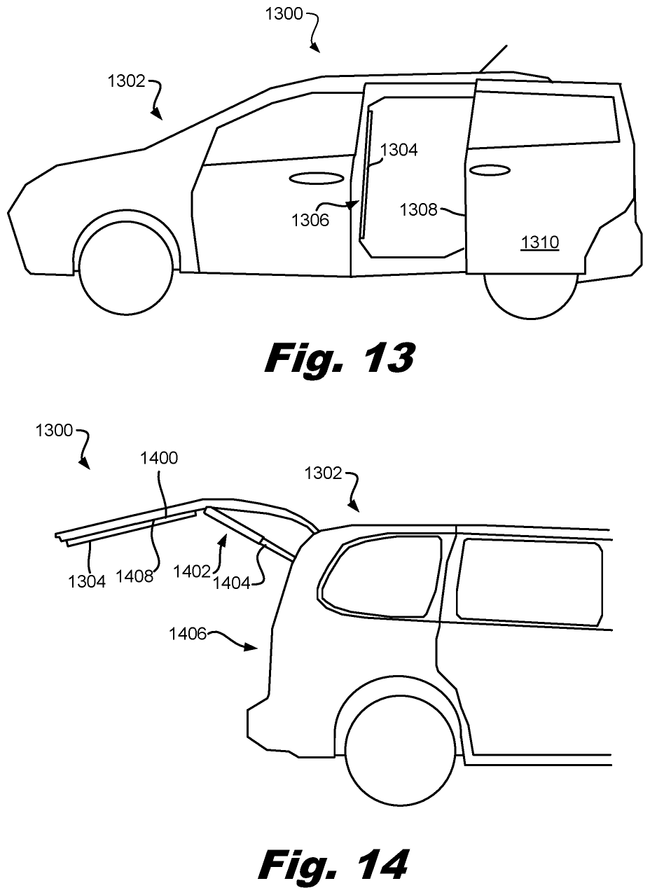

FIG. 13 depicts an example of a closure assembly 1300 incorporated into a vehicle 1302. In this example, the deformation sensor 1304 may be located on a fixed surface 1306 where a moving edge 1308 of the sliding door 1310 may approach. In some examples, when the moving edge 1308 of the sliding door 1310 is secured, the moving edge 1308 may not apply a load on the deformation sensor 1304 that would cause the capacitance to significantly change. In some cases, the deformation sensor 1304 may help to form a seal between the fixed surface 1306 and the sliding door 1310, but any capacitance changes caused by the formation of the seal may be distinguishable from capacitance changes resulting in a pinched object between the fixed surface 1306 and the sliding door 1310. In other examples, the deformation sensor 1304 may be positioned on the sliding door 1310.

FIG. 14 also depicts an example of a closure assembly 1300 incorporated into a vehicle 1302. In this example, the closure assembly 1300 includes a hinged door 1400 and the power assembly 1402 includes hydraulic actuators 1404 for moving the hinged door 1400. In this example, the deformation sensor 1304 may be attached into an inside surface 1408 of the hinged door 1400. However, in alternative examples, the deformations sensor 1304 may be placed on a fixed surface 1406 that forms a seal with the hinged door 1400 when the hinged door 1400 is closed.

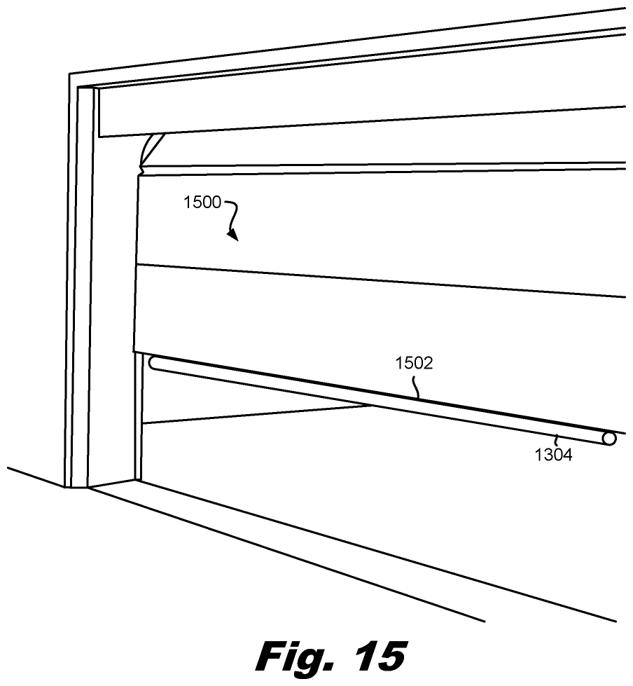

FIG. 15 depicts an example of a deformation sensor 1304 incorporated into a garage door 1500. In this example, the deformation sensor 1304 is attached to a leading edge 1502 of the garage door 1500. However, in other examples, the deformation sensor 1304 may be incorporated into the garage door at another location.

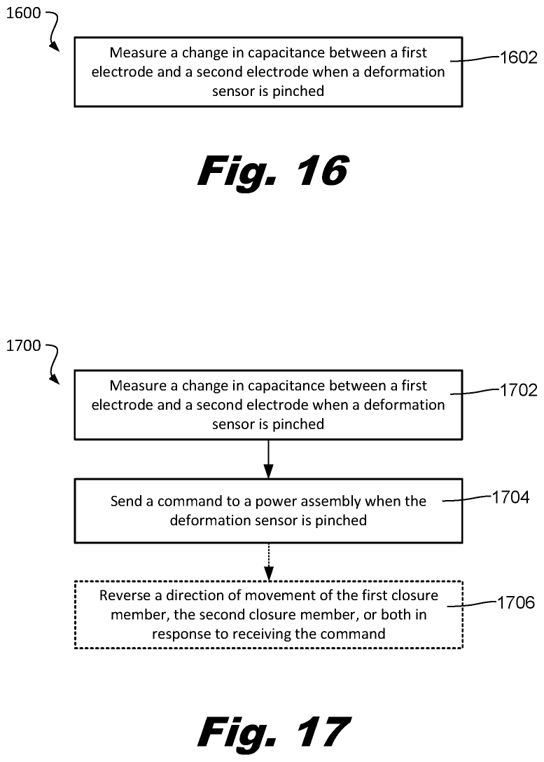

FIG. 16 depicts an example of a method 1600 of using a deformation sensor. This method 1600 may be performed based on the description of the devices, module, and principles described in relation to FIGS. 1-15. In this example, the method 1600 includes measuring 1602 a change in capacitance between a first electrode and a second electrode when a deformation sensor is pinched.

FIG. 17 depicts an example of a method 1700 of using a deformation sensor. This method 1700 may be performed based on the description of the devices, module, and principles described in relation to FIGS. 1-15. In this example, the method 1700 includes measuring 1702 a change in capacitance between a first electrode and a second electrode when a deformation sensor is pinched and sending 1704 a command to a power assembly when the deformation sensor is pinched. Method 1700 may optionally include reversing 1706 a direction of movement of the first closure member, the second closure member, or both response to receiving the command

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. An apparatus, comprising:
a deformation sensor;
the deformation sensor being made of a deformable material;
an electrode incorporated into the deformation sensor;
an electrically conductive member being spaced apart from the first electrode at a distance and being incorporated into the deformation sensor; and
a controller programmed to determine when the distance between the electrode and the electrically conductive member changes by measuring changes in capacitance between the electrode and the electrically conductive member.

2. The apparatus of claim 1, wherein the deformation sensor includes a hollow interior and the electrode and the electrically conductive member are positioned within the hollow interior.

3. The apparatus of claim 2, wherein at least one of the electrode and the electrically conductive member includes an electrically insulating coating.

4. The apparatus of claim 2, wherein the electrode is electrically insulated from the electrically conductive member.

5. The apparatus of claim 1, wherein the electrically conductive member is a second electrode.

6. The apparatus of claim 1, further including a floating coupler incorporated into the deformation sensor.

7. The apparatus of claim 1, further comprising:
a closure assembly, the closure assembly including:
a first member having a first surface;
a second member having a second surface;
wherein the second member is movable to bring the first surface and the second surface into close proximity to each other; and
wherein the deformation sensor is disposed adjacent to at least one of the first surface and the second surface.

8. The apparatus of claim 7, wherein the first member is a window frame and the second member is a window.

9. The apparatus of claim 7, wherein the first member is a door frame and the second member is a door.

10. The apparatus of claim 7, wherein the first member is a door frame and the second member is a sliding door.

11. The apparatus of claim 7, wherein the second member is a sliding door.

12. The apparatus of claim 7, wherein the second member is a revolving door.

13. The apparatus of claim 7, wherein the second member is movable with a power assembly.

14. The apparatus of claim 7, wherein the controller is programmed to move the second member away from the first member when a measured capacitance increases.

15. An apparatus, comprising:
a first member of a closure assembly;
a second member of the closure assembly movable with respect to the first member where movement of the second member is powered with a power assembly;
a deformation sensor incorporating an electrode;
a controller programmed to:
measure a change in capacitance with the electrode when the deformation sensor is pinched; and
send a command to the power assembly when the deformation sensor is pinched.

16. The apparatus of claim 15, wherein the command is to move the second member away from the first member.

17. The apparatus of claim 15, wherein the command is to stop movement of the second member.

18. The apparatus of claim 15, wherein the second member is sliding member.

19. The apparatus of claim 15, wherein the second member is rotary member.

20. The apparatus of claim 15, wherein the second member is a hinged member.
